(19) United States
(12) Patent Application Publication
(10) Pub. No.: US 2025/0301084 A1
(43) Pub. Date: Sep. 25, 2025

(54) IMAGE FORMING APPARATUS CAPABLE OF EXECUTING BINARY FILE TO REFLECT CONDITIONS DESCRIBED IN FUNCTION-ACTIVATING CONFIGURATION FILE UPON STARTUP OF IMAGE FORMING APPARATUS, AND IMAGE FORMATION SYSTEM

(71) Applicant: KYOCERA Document Solutions Inc., Osaka (JP)

(72) Inventors: Tomihito DOI, Osaka (JP); Tsuyoshi NITTA, Osaka (JP)

(73) Assignee: KYOCERA Document Solutions Inc., Osaka (JP)

(21) Appl. No.: 19/086,408

(22) Filed: Mar. 21, 2025

(30) Foreign Application Priority Data
Mar. 25, 2024 (JP) 2024-048692

(51) Int. Cl. H04N 1/00

(52) U.S. Cl. CPC H04N 1/00938; H04N 1/00244; H04N 1/0097; H04N 1/00973; H04N 2201/0094

(57) ABSTRACT

An image forming apparatus includes an image forming device, a first storage device, and a control device that functions as a controller. The first storage device stores firmware for the image forming apparatus. The firmware contains: a binary file that controls hardware capable of realizing a function installed in the image forming apparatus; and a function-activating configuration file describing an operating condition for the binary file. The controller reads, upon startup of the image forming apparatus, the binary file and the function-activating configuration file from the first storage device and executes the binary file in a manner to reflect in the binary file the condition described in the function-activating configuration file.

### INCORPORATION BY REFERENCE

This application claims priority to Japanese Patent Application No. 2024-048692 filed on 25 Mar. 2024, the entire contents of which are incorporated by reference herein.

### BACKGROUND

The present disclosure relates to image forming apparatuses and image formation systems that form an image on a sheet.

In most image forming apparatuses, such as multifunction peripherals that function as a scanner, a printer, a copier, and/or a facsimile machine, a different combination of functions is installed from model to model.

For example, there is known a first technique about an image forming apparatus in which when individual pieces of identification information are assigned to individual specific functions installed in an image forming apparatus and a piece of lifting information acquired to lift the restriction of execution of a program for realizing an individual one of the specific functions is associated with the piece of identification information on the individual specific function, the specific function meeting a user's wish can be selectively realized by lifting the restriction of execution of the program based on the piece of lifting information to realize the specific function.

There is also known a second technique about an image formation system and an image forming apparatus in which the clock can be highly accurately maintained without using broadcasting packets that might reduce the processing power of the image forming apparatus.

### SUMMARY

A technique improved over the aforementioned techniques is proposed as one aspect of the present disclosure.

An image forming apparatus according to an aspect of the present disclosure includes an image forming device, a first storage device, and a control device. The image forming device forms an image on a sheet. The first storage device stores firmware for the image forming apparatus. The control device includes a processor and functions, through the processor executing a control program, as a controller that controls the image forming apparatus. The firmware contains: a binary file that controls hardware capable of realizing a function installed in the image forming apparatus; and a function-activating configuration file describing an operating condition for the binary file. The controller reads, upon startup of the image forming apparatus, the binary file and the function-activating configuration file from the first storage device and executes the binary file in a manner to reflect in the binary file the condition described in the function-activating configuration file.

An image formation system according to another aspect of the present disclosure includes the above-described image forming apparatus and a server. The image forming apparatus further includes a first communication device. The first communication device sends and receives data to and from the server via a network. The server includes a second storage device and a second communication device. The second storage device stores the binary file and the function-activating configuration file, each file compatible with individual models of the image forming apparatus. The second communication device sends and receives data to and from the image forming apparatus via the network. The controller of the image forming apparatus downloads the binary file and the function-activating configuration file through the first communication device from the server and allows the storage device to update the binary file and the function-activating configuration file in the first storage device to the downloaded binary file and function-activating configuration file and store the updated binary file and function-activating configuration file.

### BRIEF DESCRIPTION OF THE DRAWINGS

FIG. 1 is a diagram showing a configuration of an image formation system including an image forming apparatus.

FIG. 2 is a flowchart showing the flow of creation of a binary file.

FIG. 3 is a flowchart showing the flow of creation of firmware.

FIG. 4 is a flowchart showing the flow of operation of the image forming apparatus at startup.

### DETAILED DESCRIPTION

Hereinafter, a description will be given of an image forming apparatus and an image formation system according to an embodiment of the present disclosure with reference to the drawings.

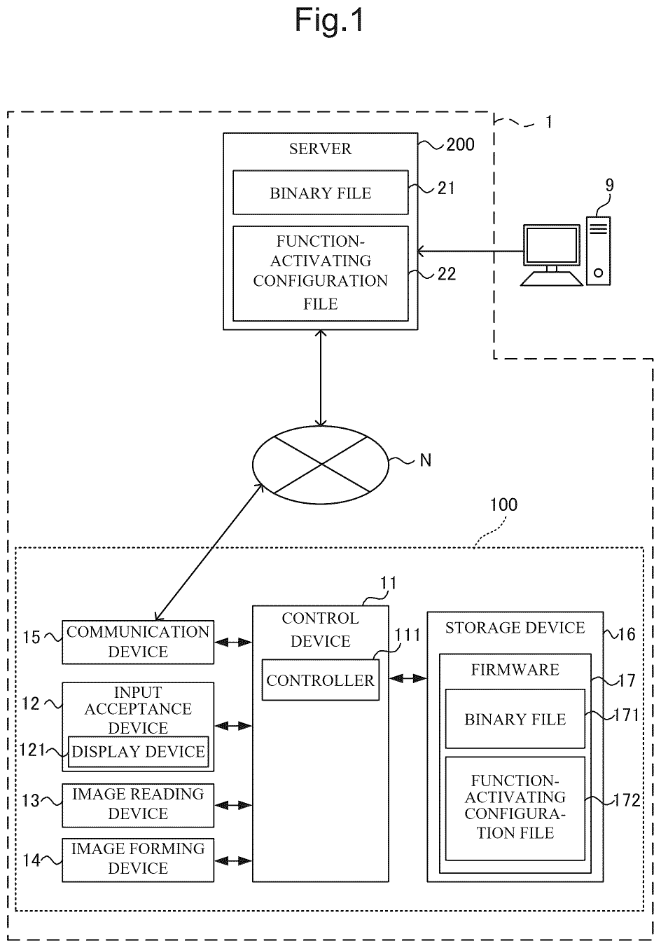

FIG. 1 is a diagram showing a configuration of an image formation system 1 including an image forming apparatus 100. The image formation system 1 includes an image forming apparatus 100, a server 200, and a network N, such as the Internet, over which the image forming apparatus 100 and the server 200 connect each other.

The image forming apparatus 100 is, for example, a printer, a copier, a scanner or a multifunction peripheral having respective functions as a printer, a copier, and a scanner. The image forming apparatus 100 includes a control device 11, an input acceptance device 12, an image reading device 13, an image forming device 14, a communication device 15, a storage device 16, and so on.

The input acceptance device 12 includes hard keys, such as a decision key for giving a definite instruction for various operations or settings and a start key, and a display device 121. The display device 121 displays an operation screen, a message or so on. The display device 121 may be formed integrally with a touch panel.

The image reading device 13 includes a scanner or the like. The image reading device 13 reads an image of an original document to acquire image data representing the image. The image forming device 14 forms, on a sheet, an image represented by image data acquired by the image reading device 13, image data received by the communication device 15 from an external device, or other image data. For example, the image forming device 14 includes an electrophotographic image forming mechanism and forms an image on a sheet in an electrophotographic system.

The communication device 15 is constituted by a communication module and so on. The communication device 15 sends and receives various types of data to and from the server 200 or an external device, such as a computer, via the network N, such as the Internet.

The storage device 16 is a large storage device including an SSD (solid state drive) or an HDD (hard disk drive) that stores image data, various programs, a data table, and so on. The storage device 16 stores firmware 17.

The firmware 17 is software that controls hardware constituting the image forming apparatus 100. The firmware 17 consists of a binary file 171 and a function-activating configuration file 172.

The binary file 171 is a program that controls hardware for realizing functions installed in the image forming apparatus 100. The function-activating configuration file 172 is a shell script file in which operating conditions, various settings, and others for the binary file 171 are described.

Generally, an image forming apparatus 100 developed by a company has a plurality of models from a model equipped with a basic function only to a model equipped with multiple functions. In developing a plurality of image forming apparatuses 100 different in combination of installed functions from each other, generally, a separate piece of software is created for each model equipped with a common combination of functions, which involves considerable time and effort to develop respective pieces of software for the plurality of models.

Adopting a common piece of hardware among a plurality of models is known to offer many merits in terms of development time, cost, and part procurement. Likewise, adoption of a common piece of software among the plurality of models enables not only reduction in development time and man-hours, but also saving of the trouble of software validation.

To this end, in this embodiment, a binary file supporting function control for all the models is created and conditions and settings compatible with functions installed in each individual one of the models are described in the function-activating configuration file. Thus, the binary file can execute processing in a manner that settings compatible with the functions of the individual model are reflected in the binary file by the function-activating configuration file (control hardware compatible with the functions of the model).

As a result, a common program can be used among all the models and can implement various functions of all the models different in combination of installed functions from each other. In other words, since operating conditions and settings on each individual one of the plurality of models different in installed functions from each other are described in a function-activating configuration file, a single binary file is compatible with all the models.

The function-activating configuration file is defined by an environment variable containing an IF statement. The environment variable is set based on the model name of the image forming apparatus 100 (a number assigned to each model classified by the combination of installed functions) upon startup of the image forming apparatus 100.

Hence, the function-activating configuration file describes only operating conditions and settings for the binary file that controls hardware capable of realizing a function or functions determinable based on the model name of the image forming apparatus 100 and installed only in one or some of the models. In other words, the function-activating configuration file does not contain settings for the binary file for the purpose of realizing a function or functions installed commonly in all the models of the image forming apparatus 100.

The function-activating configuration file is a rewritable file. For example, in changing the installed functions of the image forming apparatus 100 at user's request after the installation of the image forming apparatus 100, the user's request can be met by maintenance personnel or the like who operates, for example, the input acceptance device 12 to rewrite the function-activating configuration file.

The control device 11 is constituted by a processor, a RAM (random access memory), a ROM (read only memory), and so on. The processor is, for example, a CPU (central processing unit), an MPU (micro processing unit) or an ASIC (application specific integrated circuit). When the processor executes a control program stored in the ROM or the like, the control device 11 functions as a controller 111. The controller 111 governs the overall operation control of the image forming apparatus 100.

Upon startup of the image forming apparatus 100, the controller 111 reads the firmware 17 from the storage device 16 and executes it to activate functions. If the binary file 171 does not contain any program the operating conditions for which should be described in the function-activating configuration file 172 and which should be executed by the controller 111, the controller 111 allows the display device 121 to display an error message.

Furthermore, if the program does not work, for example, because the binary file 171 or the function-activating configuration file 172 is broken or the binary file 171 and the function-activating configuration file 172 are different in version, the controller 111 also allows the display device 121 to display an error message.

The server 200 is used for storage and sharing of data. The server 200 provides service to all models of an image forming apparatus, including the image forming apparatus 100. The server 200 stores a binary file 21 and a function-activating configuration file 22 both of which are used by individual models of the image forming apparatus, including the image forming apparatus 100.

The binary file 21 and the function-activating configuration file 22 are designed and offered support and so on by a computer 9 in a development department for the image forming apparatus 100.

When there is a need to modify the binary file 171 or the function-activating configuration file 172 stored in the image forming apparatus 100, an engineer uploads a modified binary file 171 or function-activating configuration file 172 from the computer 9 to the server 200.

The controller 111 of the image forming apparatus 100 allows the communication device 15 to download the modified binary file 171 or function-activating configuration file 172 from the server 200 and allows the storage device 16 to make an update to the downloaded file and store the updated file.

If the program does not work, for example, because the binary file 171 or the function-activating configuration file 172 stored in the image forming apparatus 100 is broken or the binary file 171 and the function-activating configuration file 172 are different in version, the controller 111 of the image forming apparatus 100 allows the communication device 15 to download a normal binary file 171 or function-activating configuration file 172 from the server 200 and allows the storage device 16 to make an update to the normal file and store the updated file.

Thus, even after the image forming apparatus 100 is installed at a user's location, an appropriate binary file 171 and an appropriate function-activating configuration file 172 can be provided to the image forming apparatus 100.

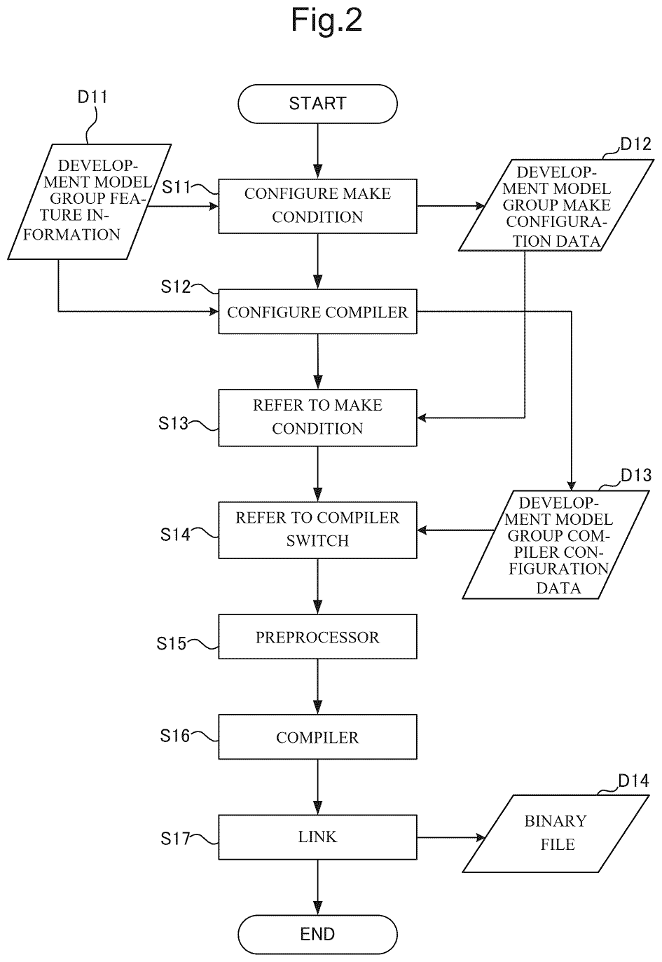

Next, a description will be given of creation of a binary file (including a binary file 171 and a binary file 21). FIG. 2 is a flowchart showing the flow of creation of a binary file.

For example, the controller of the computer 9 is first given as input data development model group feature information D11 on the combination of installed functions and the type of hardware used different from model to model, and configures a make condition (step S11) to create development model group make configuration data D12.

Subsequently, the controller of the computer 9 uses the development model group feature information D11 to configure a compiler (step S12), thus creating development model group compiler configuration data D13.

Subsequently, the controller of the computer 9 refers to the make condition in accordance with the development model group make configuration data D12 (step S13). The controller of the computer 9 refers to a compiler switch using the development model group compiler configuration data D13 (step S14).

Subsequently, the controller of the computer 9 executes a preprocessor (step S15), executes a compiler (step S16), and executes link processing to create a binary file D14 (step S17).

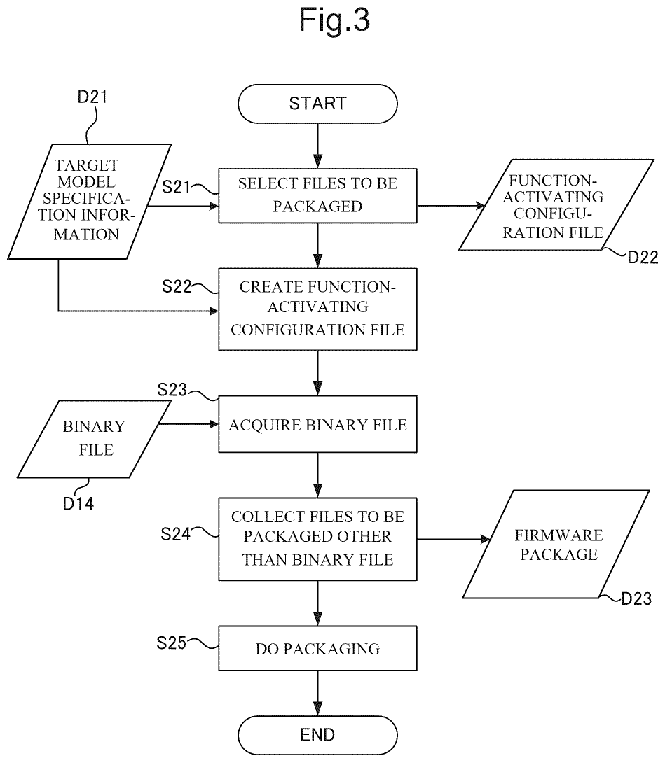

Next, a description will be given of creation of the firmware 17. FIG. 3 is a flowchart showing the flow of creation of firmware.

For example, the controller of the computer 9 first uses target function specification information D21 to select files and data to be packaged as firmware (step S21). Subsequently, the controller of the computer 9 creates a function-activating configuration file D22 (including a function-activating configuration file 172 and a function-activating configuration file 22) (step S22).

Subsequently, the controller of the computer 9 acquires the binary file D14 (step S23). Subsequently, the controller of the computer 9 collects files to be packaged into the firmware other than the binary file D14 (step S24). Subsequently, the controller of the computer 9 creates a firmware package D23 (step S25).

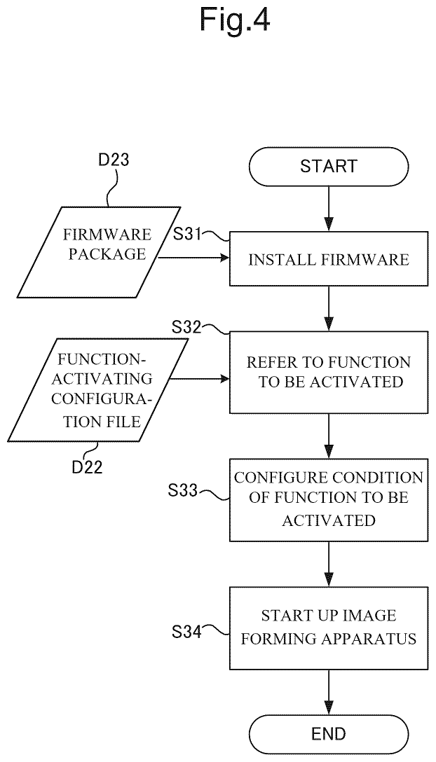

Next, a description will be given of the operation of the image forming apparatus 100 at startup. FIG. 4 is a flowchart showing the flow of operation of the image forming apparatus 100 at startup.

First, the controller 111 loads the firmware package D23 and the function-activating configuration file D22 (step S31 and step S32).

Subsequently, the controller 111 configures conditions for activating functions (step S33). In other words, processing for activating a software module capable of running installed functions of the image forming apparatus 100 is executed by the controller 111.

This processing enables the functions meeting the specification of the image forming apparatus 100 to be executed and, thus, the controller 111 starts up the image forming apparatus 100 (step S34).

As described previously, in developing a plurality of multifunction peripherals different in combination of installed functions from each other, adoption of common hardware among the plurality of models offers many merits in terms of development time, cost, and part procurement. Likewise, adoption of common software among the plurality of models enables saving of the trouble of implementing and validating overlapped functions. However, in the above-described general first technique, the user needs to select the function to be enabled, which makes it impossible to create common software among a plurality of image forming apparatuses different in combination of installed functions from each other and, therefore, makes it impossible to increase the development efficiency.

Unlike the above, in the above embodiment, since the binary file 171 and the function-activating configuration file 172 are configured to be compatible with a plurality of image forming apparatuses different in combination of installed functions from each other, the time and man-hours taken to develop them can be reduced and, thus, the development efficiency can be increased.

The present disclosure is not limited to the configuration of the above embodiment and can be modified in various ways. The structure, configuration, and processing described in the above embodiment with reference to FIGS. 1 to 4 are merely illustrative and are not intended to limit the present disclosure to them.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image forming device that forms an image on a sheet;
a first storage device that stores firmware for the image forming apparatus; and
a control device that includes a processor and functions, through the processor executing a control program, as a controller that controls the image forming apparatus,
wherein the firmware contains: a binary file that controls hardware capable of realizing a function installed in the image forming apparatus; and a function-activating configuration file describing an operating condition for the binary file, and
the controller reads, upon startup of the image forming apparatus, the binary file and the function-activating configuration file from the first storage device and executes the binary file in a manner to reflect in the binary file the condition described in the function-activating configuration file.

2. The image forming apparatus according to claim 1, wherein the function-activating configuration file describes an operating condition for the binary file that controls hardware capable of realizing a function installed in one or some of all models of the image forming apparatus.

3. The image forming apparatus according to claim 1, wherein the function-activating configuration file is a rewritable file.

4. The image forming apparatus according to claim 1,
further comprising a display device,
wherein when the binary file does not contain any program the operating condition for which should be described in the function-activating configuration file and which should be executed by the controller, the controller allows the display device to display an error message.

5. The image forming apparatus according to claim 1,
further comprising a display device,
wherein, on failure to read the function-activating configuration file from the first storage device, the controller allows the display device to display an error message.

6. The image forming apparatus according to claim 1, wherein the function-activating configuration file is defined by an environment variable containing an IF statement and the environment variable is set based on a model name of the image forming apparatus.

7. An image formation system comprising the image forming apparatus according to claim 1 and a server,
the image forming apparatus further comprising a first communication device that sends and receives data to and from the server via a network,
the server comprising:
a second storage device that stores the binary file and the function-activating configuration file, each file compatible with individual models of the image forming apparatus; and
a second communication device that sends and receives data to and from the image forming apparatus via the network,
wherein the controller of the image forming apparatus downloads the binary file and the function-activating configuration file through the first communication device from the server and allows the first storage device to update the binary file and the function-activating configuration file in the first storage device to the downloaded binary file and function-activating configuration file and store the updated binary file and function-activating configuration file.

8. The image formation system according to claim 7, wherein when the binary file does not contain any program the operating condition for which should be described in the function-activating configuration file and which should be executed by the controller, the controller of the image forming apparatus allows the first communication device to download the binary file containing the program from the server and allows the first storage device to make an update to the downloaded binary file and store the updated binary file.

9. The image formation system according to claim 7, wherein, on failure to read the function-activating configuration file, the controller of the image forming apparatus allows the first communication device to download a normal function-activating configuration file from the server and allows the first storage device to make an update to the downloaded function-activating configuration file and store the updated function-activating configuration file.
